(19) United States
(12) Patent Application Publication
(10) Pub. No.: US 2011/0089272 A1
(43) Pub. Date: Apr. 21, 2011

(54) MANUFACTURING METHOD OF MAGNESIUM ALLOY MATERIAL

(75) Inventors: Katsuyoshi Kondoh, Osaka (JP); Makoto Hotta, Osaka (JP); Jinsun Liao, Osaka (JP); Kantaro Kaneko, Osaka (JP); Norio Fujii, Nara (JP); Hirohito Kametani, Osaka (JP); Akihiko Koshi, Osaka (JP)

(73) Assignees: Katsuyoshi, Osaka (JP); KURIMOTO, LTD., Osaka (JP)

(21) Appl. No.: 12/999,319

(22) PCT Filed: Dec. 5, 2008
(86) PCT No.: PCT/JP2008/072127

§ 371 Date: Dec. 16, 2010

(30) Foreign Application Priority Data
Jun. 20, 2008 (JP) 2008-162103

(51) Int. Cl. B02C 23/00

(52) U.S. Cl. 241/25

(57) ABSTRACT

A method for manufacturing a magnesium alloy material includes the steps of: preparing a sheet or block of starting material that is made of a magnesium alloy; subjecting the starting material to a plastic working process at a temperature of 250° C. or less and a reduction ratio of 70% or more to introduce strain without causing dynamic recrystallization; pulverizing the material subjected to said plastic working process into powder; compressively deforming said powder by passing said powder between a pair of rotating rolls; and successively crushing the compressively deformed powder, which has passed between the pair of rotating rolls, into granular powder.

### TECHNICAL FIELD

The present invention relates to manufacturing of a magnesium alloy material having high tensile strength and a high proof stress, and having satisfactory impact energy absorption capability.

### BACKGROUND ART

Since magnesium alloys are expected to reduce the weight of products due to their low specific gravity, the magnesium alloys have been widely used for housings of mobile phones and portable audio equipment, automotive parts, mechanical parts, structural materials, and the like. Implementing further reduction in weight requires an increase in strength and toughness of the magnesium alloys. These characteristics of the magnesium alloys can be effectively improved by optimizing the composition and components of the magnesium alloys, and/or reducing the grain size of magnesium crystal grains that form a matrix. In particular, the grain size of magnesium crystal grains of magnesium alloy materials is conventionally reduced by using methods based on a plastic working process, such as a rolling method, an extrusion method, a forging method, or a drawing method.

Publication No. 2005-256133 of unexamined patent applications discloses a method for reducing the crystal grain size of a powder material by a roller compactor. More specifically, a starting material powder is passed between a pair of rolls so as to be compressively deformed, and then is crushed into granular powder. The compressive deformation and crushing processes are repeated several tens of times to obtain powder having a very small crystal grain size.

In the method disclosed in the above Publication, the compressive deformation and crushing processes needs to be repeated several tens of times to obtain powder having a very small crystal grain size. Thus, there is room for improvement in terms of manufacturing efficiency and economy.

It is also possible to reduce the size of a crystal structure by rolling a magnesium alloy sheet material. However, magnesium has a hexagonal close-packed structure (an HCP crystal structure), and basal slipping is dominant in a deformation mechanism at low temperatures (200° C. or less). Thus, only several percents of the magnesium alloy sheet material is processed in this low temperature range, and the rolling process is typically performed at 300° C. or higher. Even in this case, multipass rolling is performed at a reduction ratio of 25% or less in order to prevent cracking and breaking of the material.

A method for obtaining a fine crystal structure by rolling a magnesium alloy sheet at a high speed is proposed in Tetsuo Sakai et al., “Structure and Texture of High Speed Rolled AZ31 Magnesium Alloy Sheet,” pp. 27-28, Abstracts of the 109th Conference of Japan Institute of Light Metals (2005). The reduction ratio per one pass needs to be increased to increase rolling efficiency and to use a rolling process for structure control. Since only basal slipping occurs in magnesium alloys in a cold or warm temperature range, the material needs to be heated in order to successfully heavily roll the material. In order to make best use of heat generated by processing the material, and to increase the temperature of the material itself, the temperature of the material needs to be prevented from being decreased by transmission of heat to a tool and an ambient atmosphere during processing. Based on these facts, Sakai et al. experimented with high speed rolling, since they thought that it is effective to increase the processing speed to reduce the contact time between the tool and the material. The result showed that increasing the rolling speed increases rolling processability of magnesium alloys, enables a one-pass heavy rolling process to be performed, and thus enables an expanded sheet material having a fine grain structure and excellent mechanical properties to be produced.

The experimental result of Sakai et al. shows that a reduction ratio of 61% was able to be obtained by one pass not only at 350° C. but also at 200° C., when the rolling speed was as high as 2,000 m/min. Sakai et al. also reported that shear zones are generated at a rolling temperature of 100° C. or less, but as the reduction ratio increases, fine recrystallized grains are produced in the shear zones, and the recrystallized grains spread in the entire sheet at higher reduction ratio.

Sakai et al. predicted that the limit of reduction ratio per one pass increases with an increase in rolling speed. However, the highest reduction ratio confirmed in the experiments is 62%, and it is unclear whether the reduction higher than 62% are feasible or not. Moreover, the method of Sakai et al. is a method of reducing the crystal grain size by using dynamic recrystallization that occurs during high speed rolling of a magnesium alloy sheet. If an extrusion billet is produced by using such a magnesium alloy material having a fine crystal structure as obtained in this manner, and the extrusion billet is extruded at a predetermined temperature, the fine crystal grains are coarsened in the protrusion process. Thus, the final extruded magnesium alloy material has a coarsened crystal structure.

### DISCLOSURE OF THE INVENTION

It is an object of the present invention to provide a manufacturing method of a magnesium alloy material for obtaining a magnesium alloy material having a fine crystal structure and excellent mechanical properties.

A method for manufacturing a magnesium alloy material according to the present invention includes the steps of: preparing a sheet or block of starting material that is made of a magnesium alloy; subjecting the starting material to a plastic working process at a temperature of 250° C. or less and a reduction ratio of 70% or more to introduce strain into the starting material without causing dynamic recrystallization; pulverizing the material subjected to said plastic working process into powder; compressively deforming said powder by passing said powder between a pair of rotating rolls; and successively crushing the compressively deformed powder, which has passed between the pair of rotating rolls, into granular powder.

The inventors performed experiments to subject a sheet or block of magnesium alloy starting material to a plastic working process at various temperatures and reduction ratios. The result shows that, if the reduction is 70% or more, the material can be uniformly processed without breaking, and large strain can be introduced without causing dynamic recrystallization, even when the plastic working process is performed at room temperature. The upper limit of the temperature is set to 250° C. in order to prevent dynamic recrystallization.

After the plastic working process is performed at a reduction ratio of 70% or more, the material subjected to said plastic working process is pulverized into powder. The powder is compressively deformed by passing said powder between the pair of rotating rolls, and the compressively deformed powder is then crushed into granular powder. A magnesium alloy material having fine crystal grains can be obtained in this manner. If an extrusion billet is produced by compressing and compacting the granular powder having large strain introduced therein without recrystallization, dynamic recrystallization occurs in an extrusion process of the extrusion billet, and thus the final magnesium alloy material has fine crystal grains and more satisfactory impact energy absorption capability.

In order to further reduce the crystal grain size, the steps of compressively deforming said powder and crushing said compressively deformed powder may be repeated a plurality of times.

Larger strain needs to be introduced in the plastic working process in order for the magnesium alloy material to have a finer crystal structure after the extrusion process. Thus, it is desirable that the reduction ratio be 80% or more. In view of economy and in order to reliably prevent dynamic recrystallization, it is preferable that the starting material have a temperature of 50° C. or less in the plastic working process.

In one embodiment, the plastic working process for introducing large strain is a rolling process of passing the starting material between a pair of rolls. In another embodiment, the plastic working process for introducing large strain is a press working process of compressively deforming the starting material.

It is preferable that the powder billet have a temperature of 150 to 400° C. in the extrusion process.

### BRIEF DESCRIPTION OF THE DRAWINGS

FIG. 1 is a diagram illustrating an example of an apparatus for performing a manufacturing method of the present invention.

FIG. 2 is a graph showing a region of a conventional rolling process for a magnesium alloy material, a region of a high speed rolling process described in the report of Sakai et al., and a region of a plastic working process of the present invention, where the ordinate represents the rolling temperature, and the abscissa represents the reduction ratio per pass.

FIG. 3 is a graph with symbols representing the presence or absence of braking, where the ordinate indicates the rolling temperature, and the abscissa indicates the reduction ratio per pass.

FIG. 4 is a graph with symbols representing the presence or absence of recrystallization, where the ordinate indicates the rolling temperature, and the abscissa indicates the reduction ratio per pass.

FIG. 5 is a graph showing the relation between the preheat temperature of a magnesium alloy starting material and the hardness of the magnesium alloy material after a rolling process, in the case where the rolling process is performed at a reduction ratio of 80%.

FIG. 6 is a graph showing the relation between Charpy absorbed energy and proof stress of extruded materials produced by different manufacturing methods.

FIG. 7 is a bar chart showing comparison of strength and Charpy absorbed energy among extruded materials produced by different manufacturing methods.

FIG. 8 is a graph showing how strength and Charpy absorbed energy change with an increase in the number of RCP (Roll Compaction) processes after a heavy plastic working process with high reduction ratio.

### BEST MODE FOR CARRYING OUT THE INVENTION

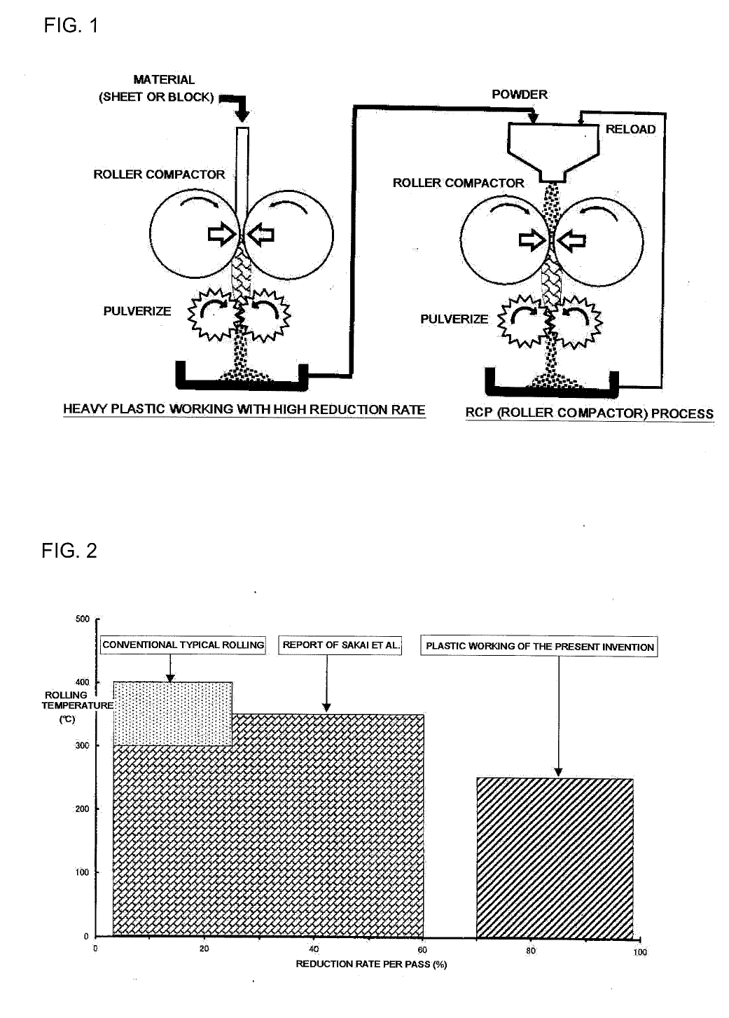

FIG. 1 is a diagram illustrating the steps that are performed to obtain a strong, highly shock-resistant magnesium alloy material by processing a sheet or block of magnesium alloy starting material.

The starting material is a sheet or block of magnesium alloy. A sheet material having a thickness of 3 to 10 mm is used as an example of the starting material. Strain will be introduced into the starting material in a later plastic working process, and a cast material is preferably used as the starting material since it has many sites for introducing strain.

The temperature of the starting material is in the range of room temperature to 250° C. The starting material is subjected to plastic working at a reduction ratio of 70% or more to introduce a large amount of strain into the starting material without causing dynamic recrystallization. In the illustrated embodiment, the plastic working process is a rolling process of passing the starting material between a pair of rolls, and the thickness of the sheet material is reduced to 0.4 to 0.9 mm by one pass. The reduction ratio is a ratio at which the thickness of the material is reduced by the processing.

If the thickness of the starting material is 3 mm, and the thickness after the plastic working is 0.9 mm, the reduction ratio can be calculated as follows.

Reduction ratio(%)={(3.0−0.9)/3.0}×100=70

Magnesium has an HCP crystal structure, and only basal slipping occurs at low temperatures. Thus, it has been common knowledge that in the case of rolling a magnesium alloy sheet material at room temperature, the reduction ratio needs to be 20% or less in order to avoid cracking and breaking of the material. Magnesium alloy sheet materials are typically rolled at 300° C. or higher in order to avoid cracking or breaking. The reduction ratio is 25% or less even in that case.

The inventors performed a rolling process on magnesium alloy sheet materials at room temperature to analyze the relation between the reduction ratio and cracking of the materials. The experiment result of the inventors shows that the materials cracked at a reduction ratio of 20 to 60%, but didn't crack at a reduction ratio of 70% or more. This result cannot be predicted from the conventional common knowledge.

In the plastic working of the starting material, it is important to introduce a large amount of strain into the material without causing dynamic recrystallization. If the material has a crystal structure due to the dynamic recrystallization in the plastic working, crystal grains are coarsened in a later extrusion process, and the final magnesium alloy material does not have a fine crystal structure. In order to prevent such dynamic recrystallization, the temperature of the starting material needs to be 250° C. or less in the plastic working process. In view of economy and in order to reliably prevent such dynamic recrystallization, the temperature of the starting material is desirably 50° C. or less in the plastic working process.

The plastic working process of the starting material is not limited to the rolling process, but may be a press working process for compressively deforming the starting material. The same processing conditions as those described above are used in the press working process as well.

As shown in FIG. 1, after the plastic working is performed at a reduction ratio of 70% or more, the material is pulverized into powder. A feature of the present invention is that this powder is further passed between a pair of rotating rolls so as to be compressively deformed, and the compressively deformed powder thus obtained is crushed into granular powder. In this manner, a large amount of strain is introduced into the material by the heavy plastic working process, and then the resultant powder is compressively deformed by a roller compactor, whereby the final magnesium alloy material has finer crystal grains, and has high strength.

The granular powder thus obtained is compressed and compacted to produce an extrusion powder billet. Preferably, this billet is extruded at a temperature of 150 to 400° C. Since this extrusion process causes dynamic recrystallization in the material containing the large amount of strain, the final magnesium alloy material has a fine crystal structure.

FIG. 2 is a graph showing a region of a conventional typical rolling process for a magnesium alloy material, a region of the high speed rolling process described in the report of Sakai et al. (Abstracts of the 109th Conference of Japan Institute of Light Metals (2005)), and a region of the plastic working process of the present invention, where the ordinate represents the rolling temperature, and the abscissa represents the reduction ratio (%) per pass.

In the conventional typical rolling process for the magnesium alloy material, the rolling temperature is 300 to 400° C., and the reduction ratio is 25% or less. In the high speed rolling process described in the report of Sakai et al., the rolling temperature is room temperature to 350° C., and the reduction ratio is about 60% or less. In the plastic working process of the present invention, the rolling temperature is room temperature to 250° C., and the reduction ratio is 70% or more.

The inventors performed a rolling process of a magnesium alloy sheet material at room temperature to analyze the relation between the reduction ratio and cracking of the material. The material cracked (broke) at the reduction ratios of 20%, 40%, and 60%. At the reduction ratios of 80% and 90%, however, the material was able to be uniformly rolled without breaking, and a large amount of strain was able to be introduced. A rolling process at a reduction ratio of 80% or more can cause some edge cracking at the top or terminal end of the material. However, this does not cause problems since the material is crushed in a later step.

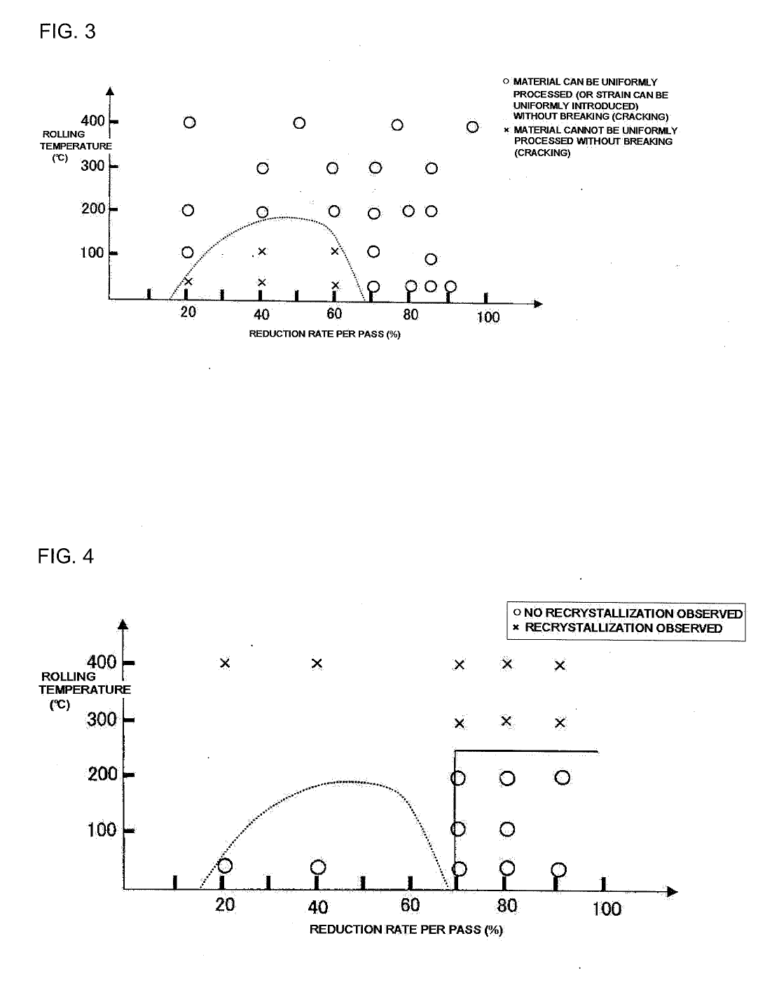

FIG. 3 is a graph with symbols representing the presence or absence of braking (cracking), where the ordinate indicates the rolling temperature, and the abscissa indicates the reduction ratio (%) per pass. At a reduction ratio of 20%, the material broke when the rolling temperature was room temperature, but was able to be uniformly rolled without breaking when the rolling temperature was 100° C. or higher. At a reduction ratio of 40 to 60%, the material broke when the rolling temperature was 100° C. or less, but was able to be uniformly rolled without breaking when the rolling temperature was 200° C. or higher. At a reduction ratio of 70% or more, the material was able to be uniformly rolled without breaking when the rolling temperature was room temperature or higher.

The inventors analyzed the relation between the preheat temperature of the magnesium alloy material in the rolling process, and the metal structure after the rolling process. When the rolling process was performed at a reduction ratio of 20% to 40%, the resultant material has no recrystallized structure at a preheat temperature of 25° C., but had a crystallized structure due to dynamic recrystallization at a preheat temperature of 400° C. When the rolling process was performed at a reduction ratio of 70%, the resultant material had no recrystallized structure at a preheat temperature of 200° C. or less, but had a crystallized structure due to dynamic recrystallization at a preheat temperature of 300° C. or more. It was recognized that when the rolling process was performed at a reduction ratio of 80%, the resultant material had no recrystallized structure at a preheat temperature of 200° C. or less, but the material was only partially crystallized by dynamic recrystallization at a preheat temperature of 250° C. When the rolling process was performed at a reduction ratio of 80% and a preheat temperature of 300° C. or more, the material was substantially entirely crystallized by dynamic recrystallization. Thus, it is important to set the upper limit of the preheat temperature to 250° C. When the rolling process was performed at a reduction ratio of 90%, the material had no recrystallized structure at a preheat temperature of 25° C., but was crystallized at a preheat temperature of 400° C.

FIG. 4 is a graph with symbols representing the presence or absence of recrystallization, where the ordinate represents the rolling temperature, and the abscissa represents the reduction ratio (%) per pass. The rolling process can be performed without causing recrystallization, if the reduction ratio is 70% or more, and the preheat temperature is 250° C. or less.

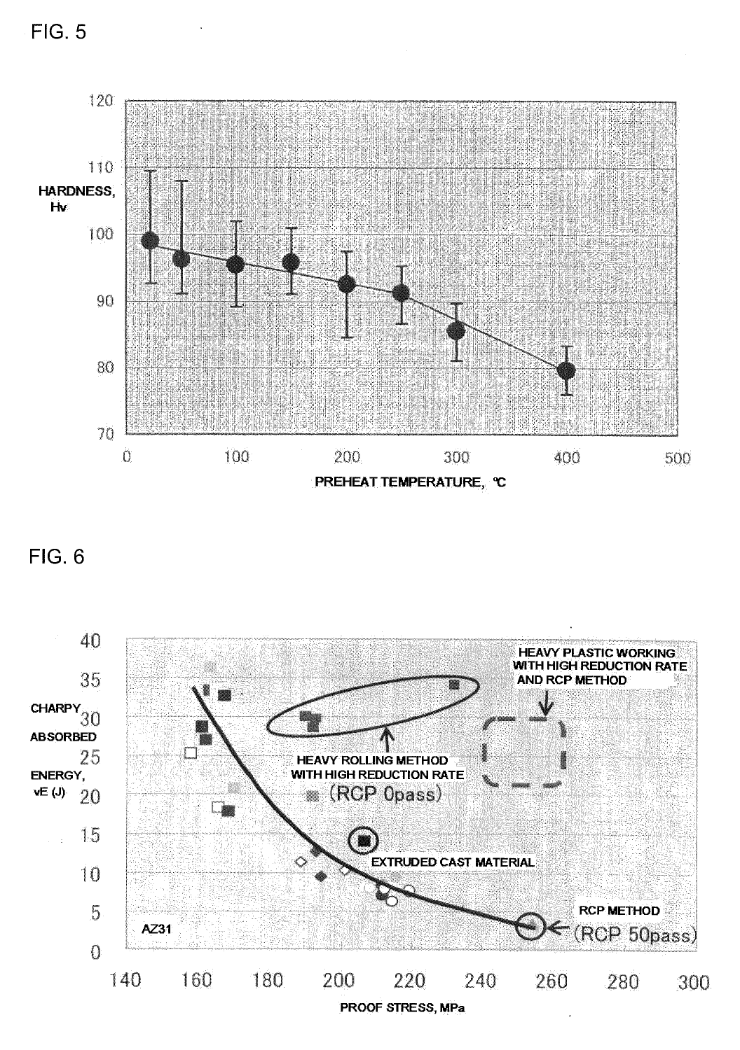

FIG. 5 is a graph showing the relation between the preheat temperature of the magnesium alloy starting material and the hardness of the magnesium alloy material after the rolling process, in the case where the rolling process is performed at a reduction ratio of 80%. It was recognized that, when the preheat temperature of the starting material was 250° C. or less, the magnesium alloy material after the rolling process had hardness (Hv) of 90 or more, but when the preheat temperature was 300° C. or more, the magnesium alloy material after the rolling process had hardness (Hv) of less than 90.

The inventors measured Charpy absorbed energy and 0.2% proof stress of extruded materials produced by the following four types of manufacturing method. The result is shown in FIG. 6.

(1) “Extruded Cast Material”

A magnesium alloy billet is produced by a casting method and is extruded.

(2) “Heavy Rolling Method with High Reduction Ratio”

A sheet or block of magnesium alloy as a starting material is subjected to plastic working at a reduction ratio of 70% or more, and the resultant material is pulverized into powder. This powder is compressed and compacted to produce a powder billet, and the powder billet is extruded.

(3) “RCP (Roll Compaction) Method”

Magnesium alloy powder as a starting material is passed between a pair of rolls so as to be compressively deformed. The compressively deformed powder is crushed into granular powder. The granular powder is compressed and compacted to produce a granular powder billet, and the granular powder billet is extruded.

(4) “Heavy Plastic Working with High Reduction Ratio and RCP Method”

This is a manufacturing method of the present invention. A sheet or block of magnesium alloy as a starting material is subjected to plastic working at a reduction ratio of 70% or more. The resultant material is pulverized into powder. This powder is passed between a pair of rolls so as to be compressively deformed. The compressively deformed powder is crushed into granular powder. The granular powder is compressed and compacted to produce a granular powder billet, and the granular powder billet is extruded.

The following can be seen from FIG. 6.

The “extruded cast material” has Charpy absorbed energy vE of about 15 J, and a proof stress of about 200 MPa.

The extruded material produced by the “heavy rolling method with high reduction ratio” has about the same proof stress as that of the “extruded cast material,” but has Charpy absorbed energy of about 30 to 35 J, which is significantly improved over the “extruded cast material.”

In the extruded material produced by the “RCP method,” the proof stress increases with an increase in the number of passes, but the Charpy absorbed energy decreases with an increase in the number of passes. If the number of passes is 50, the Charpy absorbed energy is 5 J or less.

The extruded material produced by the “heavy plastic working with high reduction ratio and RCP method” of the embodiment of the present invention has a higher proof stress than that of the extruded material of the “heavy rolling method with high reduction ratio,” and has Charpy absorbed energy slightly lower than that of the extruded material of the “heavy rolling method with high reduction ratio.” However, the extruded material produced by the “heavy plastic working with high reduction ratio and RCP method” exhibit characteristics much more satisfactory than those of the “extruded cast material.”

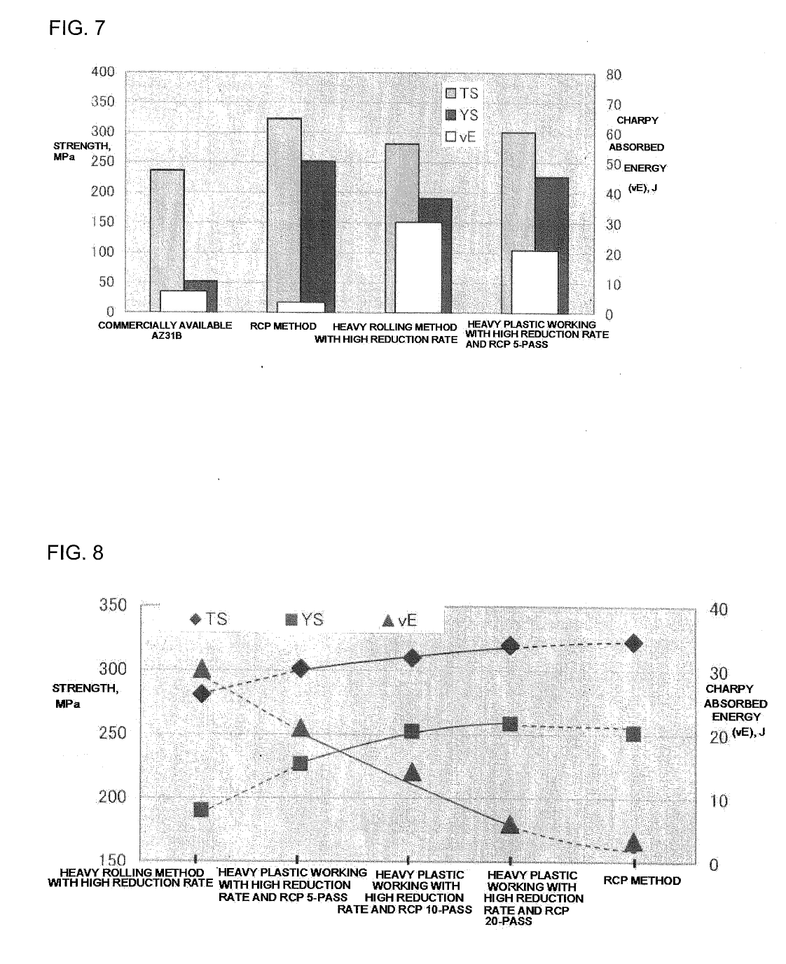

FIG. 7 is a graph showing strength characteristics of various types of extruded material. The extruded materials used for comparison are a “commercially available AZ31B alloy,” an extruded material of the “RCP method,” an extruded material of the “heavy rolling method,” and an extruded material of a “heavy plastic working and RCP 5-pass method” according to an example of the present invention. Note that an AZ31B alloy was used in each case.

The following can be seen from the result of FIG. 7.

In the extruded material of the “RCP method,” the strength (tensile strength TS, proof stress YS) is higher than that of the commercially available AZ31B alloy, but the Charpy absorbed energy (vE) is lower than that of the commercially available AZ31B alloy.

In the extruded material of the “heavy rolling method with high reduction ratio,” the Charpy absorbed energy (vE) is 3 to 4 times higher than that of the commercially available AZ31B alloy, and the strength (tensile strength TS, proof stress YS) is higher than that of the commercially available AZ31B alloy, but is lower than that of the extruded material of the “RCP method.”

In the extruded material of the “heavy plastic working with high reduction ratio and RCP 5-pass method” of the example of the present invention, the strength (tensile strength TS, proof stress YS) is slightly lower than that of the extruded material of the “RCP method,” but the Charpy absorbed energy (vE) is much higher than that of the extruded material of the “RCP method.” Moreover, the Charpy absorbed energy is reduced, but the strength is increased, as compared to the extruded material of the “heavy rolling method with high reduction ratio.

It can be seen from the above result that the extruded material of the “heavy plastic working with high reduction ratio and RCP method” of the example of the present invention has satisfactory characteristics in terms of both the strength (tensile strength TS, proof stress YS) and the Charpy absorbed energy.

FIG. 8 is a graph showing the relation between the number of passes in a roller compactor (RCP) and the strength of the magnesium alloy extruded material in the “heavy plastic working with high reduction ratio and RCP method.” The measurement result of FIG. 8 shows the following.

In the “heavy plastic working with high reduction ratio and RCP method,” the strength (tensile strength TS, proof stress YS) of the extruded magnesium alloy (AZ31B) material increases with an increase in the number of RCP processes. On the other hand, the Charpy absorbed energy decreases with an increase in the number of RCP processes. It can be seen that, if the number of RCP processes (the number of passes) is 5 to 10, the extruded magnesium alloy material has satisfactory characteristics in terms of both the strength and the Charpy absorbed energy.

More specifically, when the RCP process is performed ten times after the heavy plastic working process with high reduction ratio, the proof stress (YS) is about the same as that of the extruded material of the “RCP method,” and the Charpy absorbed energy is much higher than that of the extruded material of the “RCP method,” and is about 1.5 to 2 times higher than that of the commercially available AZ31B alloy.

Although the embodiment of the present invention has been described with reference to the drawings, the present invention is not limited to the illustrated embodiment. Various modifications and variations can be made to the illustrated embodiment within a scope that is the same as, or equivalent to the present invention.

### INDUSTRIAL APPLICABILITY

The present invention can be advantageously used as a manufacturing method of a magnesium alloy material having high strength and satisfactory impact absorption energy.

1. A method for manufacturing a magnesium alloy material, comprising the steps of:
preparing a sheet or block of starting material that is made of a magnesium alloy;
subjecting said starting material to a plastic working process at a temperature of 250° C. or less and a reduction ratio of 70% or more to introduce strain into said starting material without causing dynamic recrystallization;
pulverizing the material subjected to said plastic working process into powder;
compressively deforming said powder by passing said powder between a pair of rotating rolls; and
successively crushing said compressively deformed powder, which has passed between said pair of rotating rolls, into granular powder.

2. The method according to claim 1, wherein
said steps of compressively deforming said powder and crushing said compressively deformed powder are repeated a plurality of times.

3. The method according to claim 1, further comprising:
compressing and compacting said granular powder into a powder billet; and
extruding said powder billet.

4. The method according to claim 1, wherein
said starting material has a temperature of 50° C. or less in said plastic working process.

5. The method according to claim 1, wherein
said reduction ratio used in said plastic working process is 80% or more.

6. The method according to claim 1, wherein
said plastic working process is a rolling process of passing said starting material between a pair of rolls.

7. The method according to claim 1, wherein
said plastic working process is a plastic working process of compressively deforming said starting material.

8. The method according to claim 3, wherein
said powder billet has a temperature of 150 to 400° C. in said step of extruding said powder billet.
